(19) United States
(12) Patent Application Publication
(10) Pub. No.: US 2010/0082568 A1
(43) Pub. Date: Apr. 1, 2010

(54) METHOD AND APPARATUS FOR GENERATING INTEGRATED METADATA

(75) Inventors: Min-ho LEE, Gwacheon-si (KR); Cheol-ju HWANG, Yongin-si (KR); Soo-hong PARK, Yongin-si (KR); Jae-hwang LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/497,067

(22) Filed: Jul. 2, 2009

(30) Foreign Application Priority Data
Sep. 25, 2008 (KR) 10-2008-0094255

(51) Int. Cl. G06F 17/00

(52) U.S. Cl. 707/705; 707/E17.143

(57) ABSTRACT

A method of generating integrated metadata. The method includes receiving metadata about second contents including content access information for accessing the second contents from one or more content providers, which provide the second contents generated by changing at least one of quality, viewing cost, viewing time, and content providing method of at least one piece of first content; and generating integrated metadata using the received metadata about the second contents.

### CROSS-REFERENCE TO RELATED PATENT APPLICATION

This application claims priority from Korean Patent Application No. 10-2008-0094255, filed on Sep. 25, 2008, in the Korean Intellectual Property Office, the disclosure of which is incorporated herein by reference in its entirety.

### BACKGROUND OF THE INVENTION

1. Field of the Invention

Methods and apparatuses consistent with the present invention relate to a method and an apparatus for generating integrated metadata.

2. Description of the Related Art

Recently, the number of contents accessible to a user has been increased by geometric progression according to the widespread use of the Internet and mobile devices.

The user searches the Internet for content that the user wishes to view from among various contents.

For example, when the user wants to watch a drama recently broadcast on TV, the user types a search word related to the drama in an Internet search engine. Then, the Internet search engine provides information related to the search word, and the user may select the drama based on the provided information.

Here, the Internet search engine pre-gathers information related to a predetermined search word, and when the user inputs the predetermined search word, the Internet search engine provides the pre-gathered information to the user.

### SUMMARY OF THE INVENTION

The present invention provides a method and an apparatus for generating integrated metadata.

According to an aspect of the present invention, there is provided a method of generating integrated metadata, the method includes: receiving metadata about second contents including content access information for accessing the second contents from one or more content providers, which provide the second contents generated by changing at least one of quality, viewing cost, viewing time, and a content providing method of at least one piece of first content; and generating integrated metadata using the received metadata about the second contents.

The content access information may include content broadcasting information, which includes information about viewing time of the second contents and a broadcast channel for viewing the second contents, and/or a uniform resource locator (URL) address accessible to the second contents.

In the generating of the integrated metadata, the integrated metadata having a form classified according to one or more standards is generated. The standards include quality of each of the second contents, a content providing method of each of the second contents, a type of a broadcast channel providing each of the second contents, and performance characteristics of a device that will reproduce the second contents.

The standard or standards may be determined based on an input of a user or analysis of the second contents pre-viewed by the user.

The method may further include receiving a content recommendation list including at least one content identifier that identifies at least one piece of the first content before receiving the metadata.

The integrated metadata may include: common metadata that includes information that is common between the metadata of the second contents and the metadata of the at least one piece of first content; specialized metadata including information other than the common metadata; and a content identifier for identifying each of the second contents.

The specialized metadata may include at least one of the content access information, quality of each of the second contents, viewing cost, a content providing method, capacity, a bit rate, a screen size during reproduction, and information about a codec required for reproduction.

The method may further include: receiving the metadata about the second contents from the content providers, after the integrated metadata is generated; classifying the received metadata about the second contents into the common metadata and the specialized metadata; and updating the generated integrated metadata based on a result of classification.

The content providing method may include a method of providing the second contents in a video on demand (VOD) format, a method of providing the second contents in a broadcast content format, and a method of providing the second contents in a downloadable format.

One or more content providers may include at least one of a server for providing terrestrial broadcast content, a server for providing cable broadcast content, a server for providing satellite broadcast content, a server for providing digital multimedia broadcasting (DMB) content, and a web server.

According to another aspect of the present invention, there is provided an apparatus for generating integrated metadata, the apparatus including: a processor executing software modules and a memory storing the software modules. The software modules include a metadata receiver which receives metadata about second contents including content access information for accessing the second contents from one or more content providers, which provide the second contents generated by changing at least one of quality, viewing cost, viewing time, and a content providing method of at least one piece of first content; and a metadata generator which generates integrated metadata using the received metadata about the second contents.

The apparatus may further include, when the metadata receiver receives the metadata about the second contents from the content provider after the integrated metadata is generated, a metadata updater which classifies the received metadata about the second contents into the common metadata and the specialized metadata, and updates the generated integrated metadata based on a result of classification.

According to another aspect of the present invention, there is provided a computer readable recording medium having recorded thereon a program for executing the method of above.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method of generating integrated metadata, according to an exemplary embodiment of the present invention;

FIG. 2 is a diagram for describing the structure of integrated metadata according to an exemplary embodiment of the present invention;

FIG. 3 is a flowchart illustrating a method of updating integrated metadata, according to an exemplary embodiment of the present invention;

FIG. 4 is a flowchart for describing an exemplary use of integrated metadata generated according to an exemplary embodiment of the present invention;

FIG. 5 is a block diagram illustrating an apparatus for generating integrated metadata according to an exemplary embodiment of the present invention; and

FIG. 6 is a diagram for describing an exemplary use of an apparatus for generating integrated metadata, according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

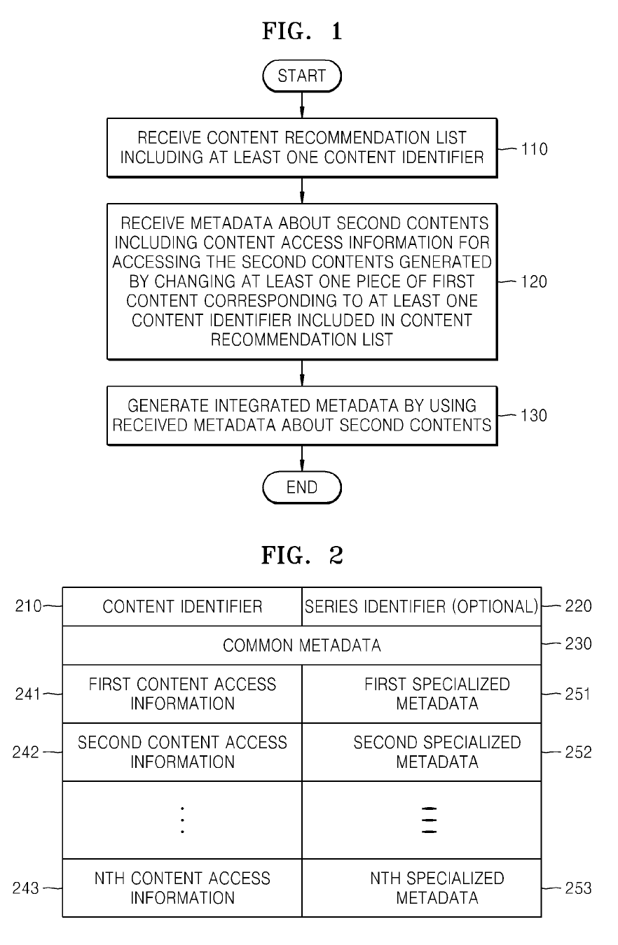

FIG. 1 is a flowchart illustrating a method of generating integrated metadata, according to an exemplary embodiment of the present invention;

In operation 110, a content recommendation list including at least one content identifier is received. The content identifier identifies at least one piece of the first content information such as a movie or a TV show.

The content recommendation list is received so as to generate integrated metadata by only using information related to content included in the content recommendation list according to an exemplary embodiment of the present invention.

Here, the content identifier may be a combination of numbers and characters or a name of the content. Also, the content recommendation list may be received from a predetermined server or a third person connected via a peer-to-peer (P2P) network.

According to another exemplary embodiment of the present invention, the integrated metadata may be generated by using information about content that is not included in the content recommendation list. Also, the integrated metadata may be generated by using information about predetermined contents without receiving the content recommendation list.

In operation 120, metadata about second contents including content access information for accessing the second contents is received from content providers providing the second contents generated by changing at least one of quality, viewing cost, viewing time, and a content providing method for at least one piece of first content corresponding to the at least one content identifier included in the content recommendation list.

The content providers provide such second contents, generated by changing the first content, so as to provide content having desired quality at a desired time according to a desired content providing method.

For example, when the first content is broadcast content about a football game that was broadcast for free on a channel of a terrestrial broadcasting station, a content provider may provide low quality broadcast content to a user having a mobile terminal that can only reproduce low quality content, or provide the broadcast content with a fee in a video on demand (VOD) format even after the broadcasting of the broadcast content is over, when a user, who could not view the broadcast content at the time the broadcast content was originally broadcast, wants to view the broadcast content in the VOD form.

As described above, the content providers provide a plurality of second contents with respect to one piece of the first content, for example, low quality second content and the second content having a VOD format.

As such, the second content is generated by changing the first content, and thus the first content may be referred to as original content and the second content may be referred to as changed content.

The content providers may include a server for providing terrestrial broadcast content, a server for providing cable broadcast content, a server for providing satellite broadcast content, a server for providing digital multimedia broadcasting (DMB) content, and a web server. The content providers may provide the second contents in a VOD format, a broadcast content format, or a downloadable format.

Meanwhile, for the user to view the second contents, the content access information for accessing each of the second contents is required.

For example, for the user to view the second content in the VOD format, the user must be aware of a uniform resource locator (URL) address for accessing the second content in the VOD format.

Accordingly, the user is provided with the metadata about the second content including the content access information for obtaining from the content providers the second content.

Here, the content access information may include content broadcasting information, which includes viewing times for the second contents, information about viewable broadcast channels for the second contents, and URL addresses for accessing the second contents.

In operation 130, the integrated metadata is generated by using the metadata about the second contents.

The metadata about the second contents may have various forms since the metadata is received from various types of content providers, and in operation 130, the integrated metadata having one form is generated by using the metadata having various forms.

In an exemplary embodiment, one piece of integrated metadata is generated by unifying the various forms of the metadata about the second contents, and thus the user may obtain the content access information for accessing the second contents through the integrated metadata, without searching for each of the metadata for the second contents.

An exemplary structure of the integrated metadata generated according to the exemplary method of FIG. 1 will now be described with reference to FIG. 2.

FIG. 2 is a diagram for describing integrated metadata according to an exemplary embodiment of the present invention.

FIG. 2 illustrates integrated metadata generated by using metadata about second contents corresponding to one piece of first content.

Referring to FIG. 2, the integrated metadata includes a content identifier 210, a series identifier 220, common metadata 230, content access information that includes first content access information 241, second content access information 242, and nth content access information 243, and specialized metadata that includes first specialized metadata 251, second specialized metadata 252, and third specialized metadata 253.

The content identifier 210 indicates an identifier of the first content.

For example, when the first content is broadcast content about a drama broadcasted on a channel of a terrestrial broadcasting station, the content identifier 210 may be a combination of numbers and characters to identify the drama, or the title of the drama.

When the first content is one of contents in series, the series identifier 220 indicates an identifier for specifying the series.

For example, when the first content is one part of a 16-part drama that forms 16 contents, the series identifier 220 includes an identifier for specifying the 16-part drama, and the content identifier 210 includes an identifier corresponding to a particular part.

When the series identifier 220 is a serial drama such as “Prison Break”, the content identifier 210 may identify a first episode of “Prison Break”.

As described above, the series identifier 220 may be the title of the drama or a combination of numbers and characters to identify the drama.

However, when the first content is a single piece of content instead of one part of serial contents, the series identifier 220 does not exist.

The common metadata 230 is formed of information that is common between metadata about the second contents and metadata about the first content.

For example, when the first content is about a movie, information about actors, the producer, the director, the synopsis, and the running time of the movie are common with the metadata about the second contents, and thus such information may be included in the common metadata 230.

The content access information 241, 242, and 243 include information for accessing each of N second contents.

The specialized metadata 251, 252, and 253 include information other than the common metadata 230, from among metadata of each of the N second contents.

For example, the first content access information 241 may include URL information for accessing second content having a VOD format. The first specialized metadata 251 may include information indicating that the second content accessible by using the first content access information 241 has a VOD format, is provided for free, and is of low quality.

As such, the content access information 241, 242, and 243 include information for accessing each of the N second contents, and the specialized metadata 251, 252, and 253 includes information not included in the common metadata 230, such as information about quality, viewing cost, a content providing method, capacity, a bit rate, a screen size during reproduction, and a codec required for reproduction of each of the N second contents.

However according to another exemplary embodiment, the specialized metadata 251, 252, and 253 may include the content access information 241, 242, and 243.

Meanwhile, the integrated metadata illustrated in FIG. 2 may be in an extensible markup language (XML) format or a text format.

Also, the integrated metadata may be in a binary format or a bitmap format such as a hexadecimal format. In this case, a database about information included in the integrated metadata is pre-generated, and a value corresponding to a predetermined piece of the information in the database is indicated in a bitmap format.

For example, when a name of some actor is to be indicated in the common metadata 230 of the integrated metadata, a value corresponding to the name in the database may be indicated in the integrated metadata in a bitmap format, instead of providing the name as text information.

Alternatively, the integrated metadata may be divided into a particular structure based on a standard. The standard may be set by information such as quality of each of the second contents, a content providing method of each of the second contents, a type of a broadcast channel providing each of the second contents, and performance characteristics of a device to reproduce each of the second contents.

Here, the standard may be determined based on an input of a user or on analysis about the second contents that are pre-viewed by the user.

For example, when the user sets viewing cost of the second content as a standard, the integrated metadata may be generated after being divided into metadata about the second contents that are free and metadata about the second contents that are not free.

Alternatively, when most of the second contents pre-viewed by the user have a VOD format, the integrated metadata may be generated after being divided into metadata about the second contents in the VOD format and metadata about the second contents not in the VOD format.

As described above, when the integrated metadata has a form divided according to a predetermined standard, the user can easily search for desired information in the integrated metadata. According to another exemplary embodiment of the present invention, the integrated metadata including only specific information divided according to a predetermined standard may be generated.

In the exemplary embodiment, the integrated metadata corresponding to one piece of first content is illustrated, but the integrated metadata may be generated for a plurality of first contents.

The generated metadata may be updated with new information.

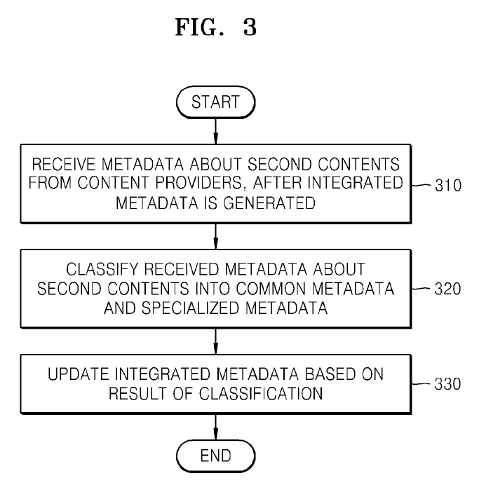

FIG. 3 is a flowchart illustrating a method of updating integrated metadata, according to an exemplary embodiment of the present invention.

In operation 310, metadata about second contents is received from content providers, after integrated metadata is generated.

Here, the metadata about the second contents may be received at uniform intervals after the integrated metadata is generated.

In operation 320, the received metadata about the second contents is classified into common metadata and specialized metadata.

In operation 330, the integrated metadata is updated based on a result of classification.

In detail, information classified to be included in the common metadata from among the metadata about the second contents received from the content providers is added to the common metadata of the integrated metadata, and other information is added to the specialized metadata of the integrated metadata.

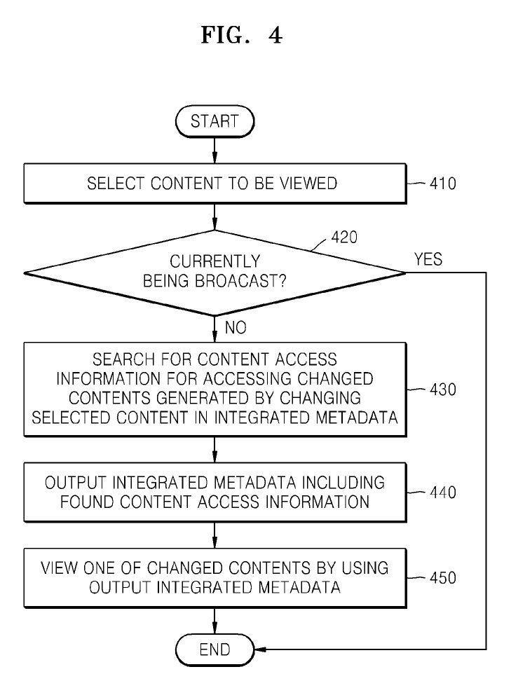

FIG. 4 is a flowchart for describing an exemplary use of integrated metadata generated according to an exemplary embodiment of the present invention.

In operation 410, a user selects content desired to be viewed.

Here, the user may select the content by searching for the content in the Internet or according to a recommendation of friends.

In operation 420, it is determined whether the content selected by the user is currently being broadcast and/or played.

For example, the user wants to view a football game that was to be broadcast in a channel of a terrestrial broadcasting station, and it is determined whether the football game is currently being broadcast or is over in operation 420.

Here, when the selected content is currently being broadcast, the user may directly view the selected content.

When the selected content cannot be currently viewed (when it is not being broadcast at the present time), the user searches for content access information for accessing changed contents generated by changing at least one of quality, viewing cost, viewing time, and a content providing method of the selected content from integrated metadata.

Here, the selected content corresponds to the first content described above, and the changed contents correspond to the second contents described above.

In operation 440, the integrated metadata including the content access information for accessing the changed contents is output.

In operation 450, the user views one of the changed contents by using the output integrated metadata.

For example, when the user wants to view broadcast content about the football game that was to be broadcast on the channel of the terrestrial broadcasting station, the output integrated metadata may indicate a channel number of a cable TV that re-broadcasts the football game, a re-broadcasting time, and a URL address of a site that provides the football game in a VOD format. The user may view VOD content by connecting to a URL address for providing the VOD content as one of the changed contents about the broadcast content, by referring to the integrated metadata.

As such, when the integrated metadata is output, the integrated metadata that only includes specific information according to a standard set by the user may be output.

For example, when a mobile device of the user only reproduces low quality contents, the integrated metadata that only includes information related to changed low quality contents may be output, and when a user wants to view changed contents broadcast on a cable broadcasting station, metadata only including information about a broadcasting time and a channel of the changed contents broadcast on the broadcasting station may be output.

Meanwhile, unlike the exemplary embodiment, when generating the integrated metadata before the user selects the content, metadata about the changed content corresponding to the selected content may be received and the integrated metadata may be generated by using the received metadata about the changed contents. However in this case, it takes too long to generate the integrated metadata after the user selects the content.

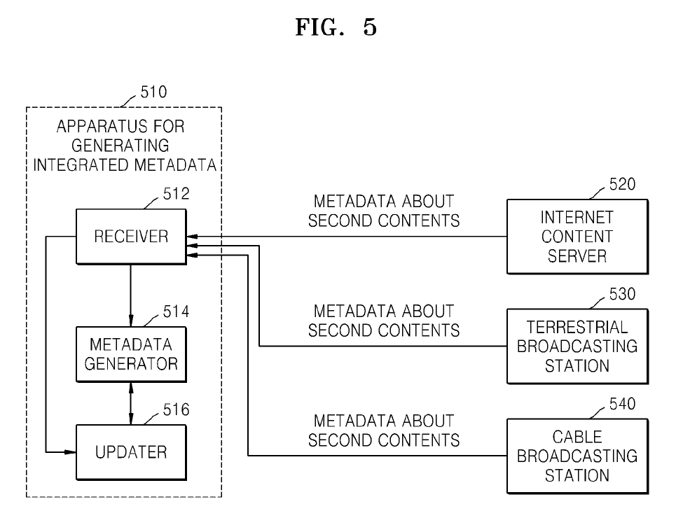

FIG. 5 is a block diagram illustrating an apparatus 510 for generating integrated metadata according to an exemplary embodiment.

Referring to FIG. 5, the apparatus 510 includes a receiver 512, a metadata generator 514, and an updater 516.

The receiver 512 receives metadata about second contents including content access information for accessing the second contents generated by changing first content from a plurality of content providers 520, 530, and 540.

As described above, the second contents are contents generated by changing at least one of quality, viewing cost, viewing time, and a content providing method of at least one piece of first content.

As illustrated in FIG. 5, the content providers 520, 530, and 540 may include a server for providing a satellite broadcast content, a server for providing DMB content, and a web server, aside from the Internet content server 520, the terrestrial broadcasting station 530, and the cable broadcasting station 540.

Here, the receiver 512 may receive the metadata about the second contents from a server for providing only a broadcasting organization table and an electronic program guide (EPG).

The Internet content server 520 may provide the second contents in a VOD format, the terrestrial broadcasting station 530 may provide the second contents in an terrestrial broadcast content format, and the cable broadcasting station 540 may provide the second contents in a cable broadcast content format. Alternatively, the Internet content server 520, the terrestrial broadcasting station 530, and the cable broadcasting station 540 may provide various types of second contents.

The metadata generator 514 generates integrated metadata by using the metadata about the second contents received through the receiver 512.

When the receiver 512 receives the metadata about the second contents from the content providers 520, 530, and 540 after the integrated metadata is generated, the updater 516 updates the integrated metadata by using the received metadata about the second contents.

Here, the updater 516 may classify the received metadata about the second contents into common metadata and specialized metadata, and update the integrated metadata based on a result of classification.

In detail, the updater 516 updates the integrated metadata by adding information classified to include common metadata from among the metadata about the second contents received from the content providers 520, 530, and 540 to the common metadata of the integrated metadata, and adding other information in the specialized metadata of the integrated metadata. According to another exemplary embodiment, the updater 516 may be located in a separate apparatus and not included in the apparatus 510.

Meanwhile, the apparatus 510 may be installed in a user device, such as a television (TV), a personal computer (PC), a portable multimedia player (PMP), or a mobile terminal.

For example, the TV may generate integrated metadata by using the apparatus 510, and output the generated integrated metadata on a screen.

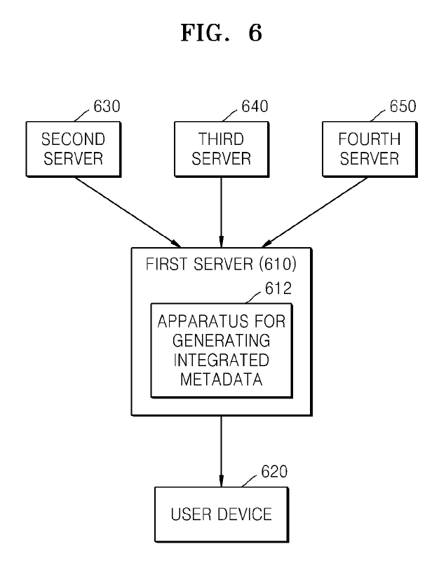

FIG. 6 is a diagram for describing an exemplary use of an apparatus 612 for generating integrated metadata, according to an exemplary embodiment of the present invention.

Referring to FIG. 6, the apparatus 612 is installed in a first server 610, and generates integrated metadata by receiving metadata about second contents from other servers such as second server 630, third server 640, and fourth server 650.

As such, when the apparatus 612 generates the integrated metadata, the first server 610 transmits the generated integrated metadata to a user device 620, and the user device 620 outputs the received integrated metadata.

In other words, the user device 620 does not participate in generating the integrated metadata, and only outputs the integrated metadata received from the first server 610.

Here, when the user device 620 receives the integrated metadata from the first server 610, the user device 620 may classify the integrated metadata according to a standard, such as the quality of each of the second contents, a content providing method of each of the second contents, types of broadcast channels providing each of the second contents, and performance of a device to reproduce each of the second contents, and then output the integrated metadata accordingly.

However, according to another exemplary embodiment, the user device 620 may receive the integrated metadata that is already classified according to such a standard from the first server.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and other storage media. Alternatively, exemplary embodiments of the present invention can be implemented on a transmission medium such as carrier waves (e.g., transmission through the Internet).

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of generating integrated metadata, the method comprising:
receiving metadata about second contents including content access information for accessing the second contents from at least one content provider, which provides the second contents that are generated by changing at least one of quality, viewing cost, viewing time, and a content providing method of at least one piece of first content; and
generating by a computer integrated metadata using the received metadata about the second contents.

2. The method of claim 1, wherein the content access information comprises at least one of content broadcasting information, which comprises information about viewing time of the second contents and a broadcast channel for viewing the second contents, and a uniform resource locator (URL) address accessible to the second contents.

3. The method of claim 1, wherein the generating of the integrated metadata comprises generating the integrated metadata having a form classified according to at least one standard, wherein standards comprise quality of each of the second contents, a content providing method of each of the second contents, a type of a broadcast channel providing each of the second contents, and performance characteristics of a device that will reproduce the second contents.

4. The method of claim 3, wherein the at least one standard is determined based on an input of a user or analysis of the second contents pre-viewed by the user.

5. The method of claim 1, further comprising receiving a content recommendation list including at least one content identifier that identifies at least one piece of first content before receiving the metadata.

6. The method of claim 1, wherein the integrated metadata comprises:
common metadata comprising information that is common between the metadata of the second contents and the metadata of the at least one piece of first content;
specialized metadata comprising information other than the common metadata; and
a content identifier for identifying each of the second contents.

7. The method of claim 6, wherein the specialized metadata comprises at least one of the content access information, quality of each of the second contents, viewing cost, a content providing method, capacity, a bit rate, a screen size during reproduction, and information about a codec required for reproduction.

8. The method of claim 6, further comprising:
receiving the metadata about the second contents from the content providers, after the integrated metadata is generated;
classifying the received metadata about the second contents into the common metadata and the specialized metadata; and
updating the generated integrated metadata based on a result of classification.

9. The method of claim 1, wherein the content providing method comprises a method of providing the second contents in a video on demand (VOD) format, a method of providing the second contents in a broadcast content format, and a method of providing the second contents in a downloadable format.

10. The method of claim 1, wherein the at least one content provider comprises at least one of a server for providing terrestrial broadcast content, a server for providing cable broadcast content, a server for providing satellite broadcast content, a server for providing digital multimedia broadcasting (DMB) content, and a web server.

11. An apparatus for generating integrated metadata, the apparatus comprising:
a processor executing software modules; and
a memory storing the software modules, wherein the software modules comprise:
a metadata receiver which receives metadata about second contents including content access information for accessing the second contents from at least one content provider, which provides the second contents generated by changing at least one of quality, viewing cost, viewing time, and a content providing method of at least one piece of first content; and
a metadata generator which generates integrated metadata using the received metadata about the second contents.

12. The apparatus of claim 11, wherein the content access information comprises at least one of content broadcasting information, which comprises information about viewing time of the second contents and a broadcast channel for viewing the second contents, and a uniform resource locator (URL) address accessible to the second contents.

13. The apparatus of claim 11, wherein the metadata generator generates the integrated metadata having a form classified according to at least one standard, wherein standards comprise quality of each of the second contents, a content providing method of each of the second contents, a type of a broadcast channel providing each of the second contents, and performance of a device that will reproduce the second contents.

14. The apparatus of claim 13, wherein the metadata generator generates the integrated metadata based on an input of a user or analysis on the second contents pre-viewed by the user.

15. The apparatus of claim 11, wherein the metadata receiver receives a content recommendation list including at least one content identifier that identifies at least one piece of first content before receiving the metadata.

16. The apparatus of claim 11, wherein the integrated metadata comprises:
common metadata comprising information that is common between the metadata of the second contents and the metadata of the at least one piece of first content;
specialized metadata comprising information other than the common metadata; and
a content identifier for identifying each of the second contents.

17. The apparatus of claim 16, wherein the specialized metadata comprises at least one of the content access information, quality of each of the second contents, viewing cost, a content providing method, capacity, a bit rate, a screen size during reproduction, and information about a codec required for reproduction.

18. The apparatus of claim 16, further comprising, when the metadata receiver receives the metadata about the second contents from the content provider after the integrated metadata is generated, a metadata updater which classifies the received metadata about the second contents into the common metadata and the specialized metadata, and updates the generated integrated metadata based on a result of classification.

19. The apparatus of claim 11, wherein the content providing method comprises a method of providing the second contents in a video on demand (VOD) format, a method of providing the second contents in a broadcast content format, and a method of providing the second contents in a downloadable format.

20. The apparatus of claim 11, wherein the at least one content provider comprises at least one of a server for providing terrestrial broadcast content, a server for providing cable broadcast content, a server for providing satellite broadcast content, a server for providing digital multimedia broadcasting (DMB) content, and a web server.

21. The apparatus of claim 11, wherein the apparatus is mounted on one of a television (TV), a personal computer (PC), a portable multimedia player (PMP), a mobile terminal, and a server.

22. A computer readable recording medium having recorded thereon a program for executing the following operations:
receiving metadata about second contents including content access information for accessing the second contents from at least one content provider, which provides the second contents that is generated by changing at least one of quality, viewing cost, viewing time, and a content providing method of at least one piece of first content; and
generating integrated metadata using the received metadata about the second contents.
